(19) United States
(12) Patent Application Publication
(10) Pub. No.: US 2018/0095500 A1
(43) Pub. Date: Apr. 5, 2018

(54) TAP-TO-DOCK

(71) Applicant: INTEL CORPORATION, SANTA CLARA, CA (US)

(72) Inventors: Daniel COHN, Raanana (IL); Tal DAVIDSON, Petach Tikva (IL); Elad LEVY, Nes Ziona (IL); Solomon TRAININ, Haifa (IL); Boris YUROVITSKY, Rishon LeZion (IL)

(21) Appl. No.: 15/281,444

(22) Filed: Sep. 30, 2016

(51) Int. Cl. G06F 1/16; H04B 5/00; H04L 29/06; G06F 13/40; H04W 12/04

(52) U.S. Cl. CPC G06F 1/1632; H04B 5/0031; H04L 63/061; H04L 63/0492; H04L 63/0807; H04W 12/04; G06F 13/4081

(57) ABSTRACT

A novel docking process introduces a new handshake scheme between a first device (referred to herein as the “Dockee”) and a docking device (referred to simply as the “Dock”) to communicate a user's intention to connect the Dockee and the Dock (i.e., dock the Dockee to the Dock). The handshake consists of two steps: 1) establish a connection over a near field communication (NFC) link to convey information about the docking event; and 2) establish a second connection over the Wireless Channel to connect the Dockee and the Dock. The first step delivers a one-time secure connection token to the Dock over the NFC channel. Further, the presence of the NFC channel establishes the physical proximity of the user to the Dock. During step 2, a new Information Element is introduced to deliver the token back to the Dockee to allow for authentication and “closure” of the handshake.

### TECHNICAL FIELD

An exemplary aspect is directed toward docking of devices. More specifically, an exemplary aspect is directed toward wireless docking of a device with a dock and the process or protocol for docking.

### BACKGROUND

Wireless docking and/or Wireless Gigabit (WiGig) Docking enables a new and improved user experience over traditional wired docks. Simply stated, wireless docking does not require wires. Thus, users are no longer required to plug-in cables into their portable device or to plug the device into a dock.

For wireless connections with a dock, once a user's portable device (referred to as the “Dockee”) is in range of an associated Wireless Dock (referred to as the “Dock”), the wireless connection can be made automatically. However, a question arises as to the user's intent—does the user actually want to dock? Without some type of input from the user, the following two scenarios are indistinguishable: (a) a user placing the Dockee on the desk—with an intent to connect to the dock; and (b) a user standing next to her office chatting to a colleague—without any intention to connect.

Traditionally, the below methods are used to solve the question of user's intention:
Manual Connection—with a manual connection, once the user is in range of his/her dock, the user must explicitly signal the intention to dock by interacting with the Dockee device. Unfortunately, “manual” connections have problems. The Dockee device may not feature a unique hardware interface (e.g., a docking button) for such interaction. Interacting with a software application used for docking may be inconvenient. For example, to interface with the software application, the user may need to unlock the device, open the device, locate the software, execute the software, etc.
Automatic Connection—with an automatic connection, once the Dockee is in range of a previously “paired” dock, the connection is made without any further interaction. Obviously, the automatic connection ignores the user's intent and can lead to unwanted connections.

The above two methods provide trade-offs between user privacy and quality-of-experience. With an Automatic Connection, which provides a superior experience, user's privacy may be violated when the connection was not intended. With a Manual Connection, the user-experience is poor.

There may be another alternative involving a physical interface, e.g. a button, on the dock. Yet, this solution still does not address all privacy concerns because this arrangement does not identify the person pressing the button. Thus, an attacker may be able to “steal” the user's screen if the user is in connection range of the dock but is not observing the monitor connected to the dock.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of an embodiment of a system for conducting wireless docking;

FIG. 2A is a block diagram of an embodiment of a device (Dockee) for conducting wireless docking;

FIG. 2B is a block diagram of an embodiment of another device (Broker) for conducting wireless docking;

FIG. 2C is a block diagram of an embodiment of a dock (Dock) for conducting wireless docking;

FIG. 3A is a block diagram of an embodiment of a data structure that stores data for conducting wireless docking;

FIG. 3B is a block diagram of an embodiment of another data structure that is sent during wireless docking;

FIG. 4 is a signalling diagram of an embodiment of a process for conducting wireless docking;

FIG. 5 is another signalling diagram of an embodiment of a process for conducting wireless docking;

FIG. 6 is another signalling diagram of an embodiment of a process for conducting wireless docking;

FIG. 7 is a flow chart of an embodiment of a process for conducting wireless docking from the perspective of a device (a Dockee);

FIG. 8 is a flow chart of an embodiment of a process for conducting wireless docking from the perspective of another device (a Broker);

FIG. 9 is a flow chart of an embodiment of a process for conducting wireless docking from the perspective of a Dock; and

FIG. 10 illustrates an exemplary device/dock.

### DESCRIPTION OF EMBODIMENTS

Embodiments herein are generally directed to wireless docking and wireless docking systems. Various embodiments are directed to wireless docking performed according to one or more wireless communication standards. Some embodiments may involve wireless communications performed according to interface standards developed by the WiMAX Forum, the WiGig Alliance, the WiFi Alliance (WFA), the various IEEE 802.11 working groups focused on wireless technologies, and/or the various industry groups focused on wireless communications.

The embodiments presented herein introduce a new “handshake” scheme between a first device (referred to herein as the “Dockee”) and a docking device (referred to simply as the “Dock”) to communicate a user's intention to connect the Dockee and the Dock (i.e., dock the Dockee to the Dock). The handshake consists of two steps:
Step 1: Establish a connection over a near field communication (NFC) link to convey information about the docking event; and
Step 2: Establish a second connection over the Wireless Channel to connect the Dockee and the Dock

Step 1 delivers a one-time secure connection token to the Dock over the NFC channel. Further, the presence of the NFC channel establishes the physical proximity of the user to the Dock.

During Step 2, a new Information Element is introduced to deliver the token back to the Dockee to allow for authentication and “closure” of the handshake.

The above process explicitly and securely communicates the user's intention regarding docking through a simple and intuitive interaction, allowing for an improved Wireless Docking experience, while eliminating privacy concerns. In addition, since NFC may not be available on the Dockee or may be inconvenient to use directly (as it is with most modern Notebook designs), we suggest a scheme that allows a user to employ a Broker device, e.g. a smart-phone, to handle the NFC communications.

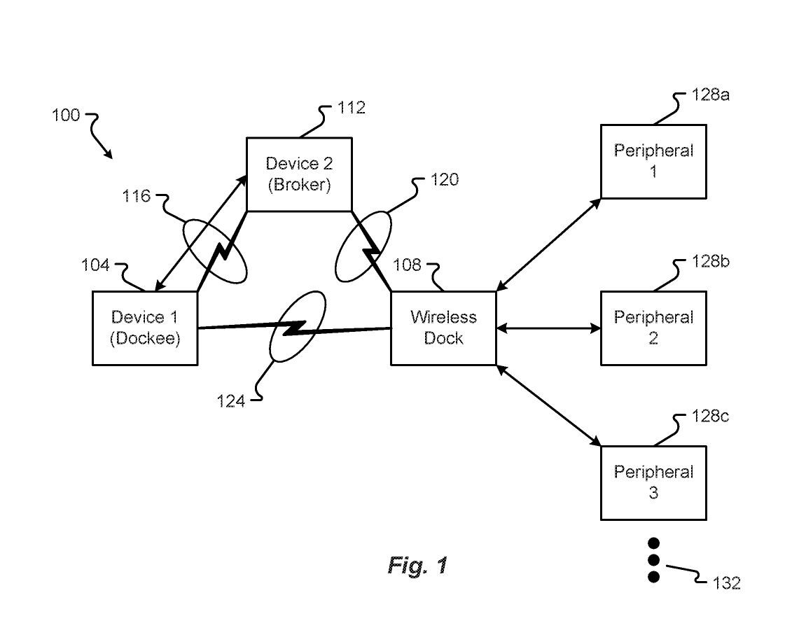

An embodiment of an environment 100 for conducting wireless docking may be as shown in FIG. 1. The environment 100 may include a first device 104 (the Dockee), a second device 112 (the Broker), and a dock 108 (the Dock). The three devices 104, 108, and 112 work in concert to allow for a new process of conducting wireless docking between the Dockee 104 and the Dock 108. Each of the different devices 104, 108, 112 may be wireless communication devices having hardware and software that may be as described in conjunction with FIG. 10. The first device 104 and second device 112 can be any type of wireless or mobile device, such as a laptop, a notebook, a mobile phone, etc.

The Dock 108 can be a suite of connections and/or processing capabilities that provide further functionality to the Dockee 104. The Dock 108 may allow for the connection to one or more peripherals 128a-128c. Only three peripherals 128 are shown, but there may be more, or fewer peripherals 128 connected to the Dock 108, as represented by ellipses 132. The peripherals 128 can include keyboards, additional screens, speakers, etc.

The Dock 108 may communicate with the Dockee 104, through a wireless connection 124. The wireless connection 124 may be conducted based on any WiFi standard (e.g., standards from the WFA, WiGig Alliance, IEEE 802.11 working groups, etc.), for example, a Wi-Fi standard that may include the one or more standards published by the WiMAX standard group. The Dockee 104 may connect or communicate with the Broker 112 either through a wireless or physically-wired connection 116. The connection 116 may be temporary, as the Dockee 104 and Broker 112 may connect for atemporary period of time to exchange information to conduct the method as described herein. Similarly, the Broker 112 and the Dock 108 may connect through a wireless connection 120. This wireless connection 120 may be an NFC connection. The NFC connection 102 may allow the Broker 112 to exchange information with the Dock 108 for a temporary period of time. The NFC connection 120 may be any Bluetooth, Radio Frequency ID, or other applicable communication protocol or system. Importantly, the range of the NFC connection is very small (e.g., a few inches to a few feet), and thus, is not similar to WLANs or other wireless networks that can communicate over tens or hundreds of feet. Thus, if the Broker 112 and the Dock 108 establish a communications link 120, it must mean that the Broker 112 is in physical proximity with (i.e., near to) the Dock 108. In other words, the Broker 112 is within inches or a few feet of the Dock 108.

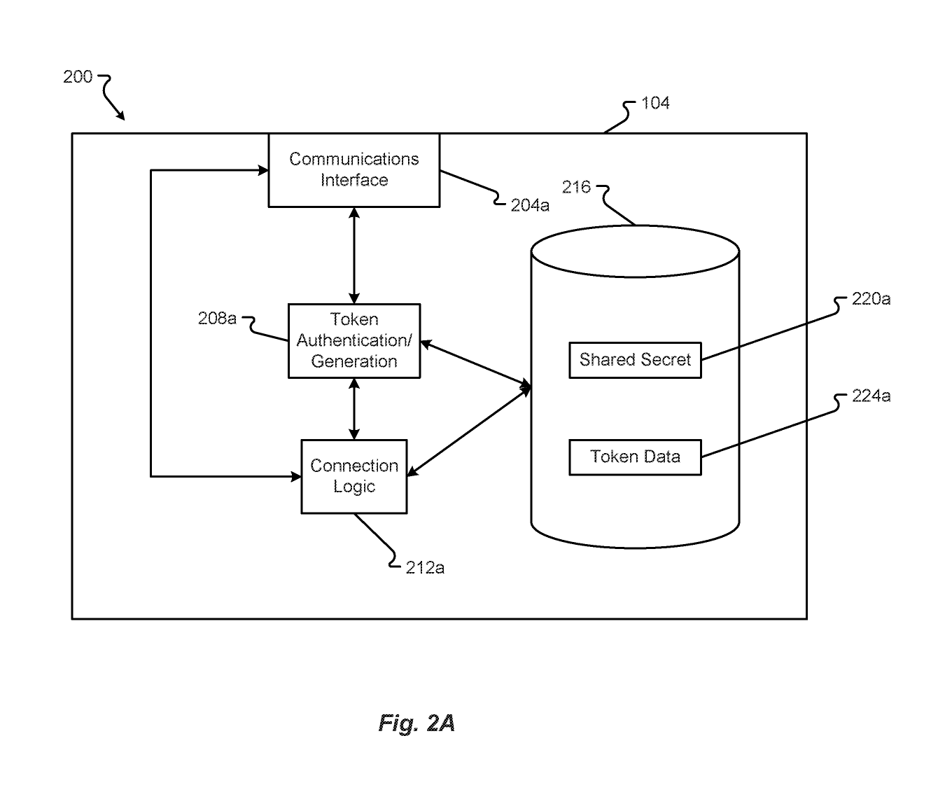

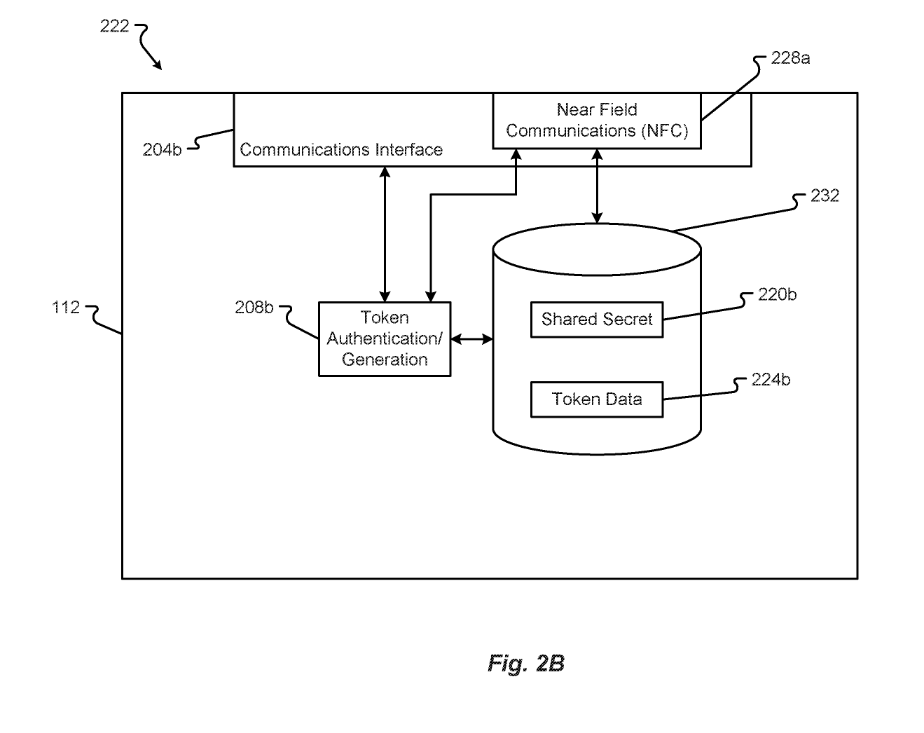

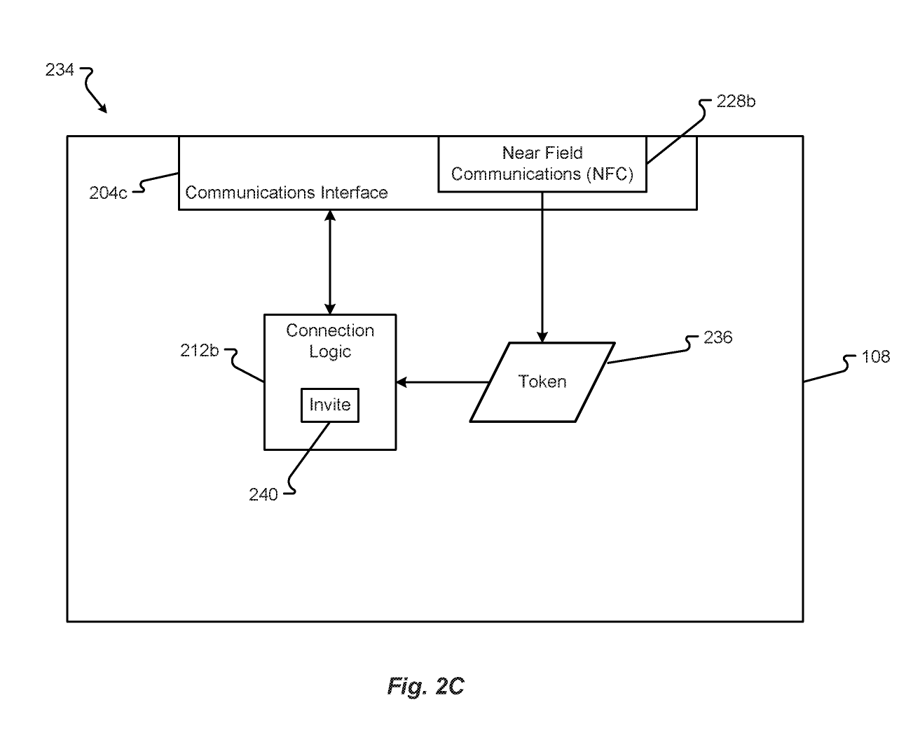

An embodiment of the one or more hardware and/or software components 200 that form the Dockee 104 may be as shown in FIG. 2A. The software/hardware components 200 can include one or more of, but are not limited to, a communications interface 204a, a token authentication/generation component 208a, a connection logic 212a, and/or a data store 216.

The communications interface 204a can be any type of communications interface that may conduct communications either through a wired or wireless connection. As such, the communications interface 204a can conduct wireless or Wi-Fi communications with the Dock 108 and/or with the Broker 112. The communications interface 204a is operable to receive, manipulate, or manage data through inputs and outputs and send that data on to other internal components, such as the token authentication generation component 208a and/or the connection logic 212a.

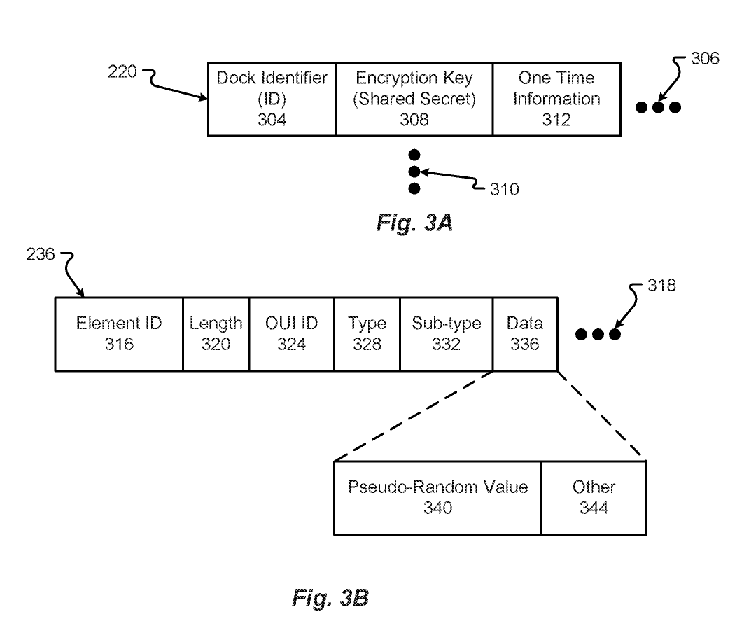

The token authentication generation component 208 can encrypt and/or decrypt information to create a token with a shared secret 220a, as stored in the data store 216. Any type of encryption hushing function, etc. may be used to create the token, for example, Pretty Good Privacy (PGP) or other encryption methods. Further, the token authentication generation component 208 may use token data 224a in the generation or authentication of a token. Tokens may be shared with the Broker 112 for use in determining whether a wireless connection between the Dockee 104 and the Dock 108 is desired. A token can be a type of data format that may be as described in conjunction with FIG. 3B.

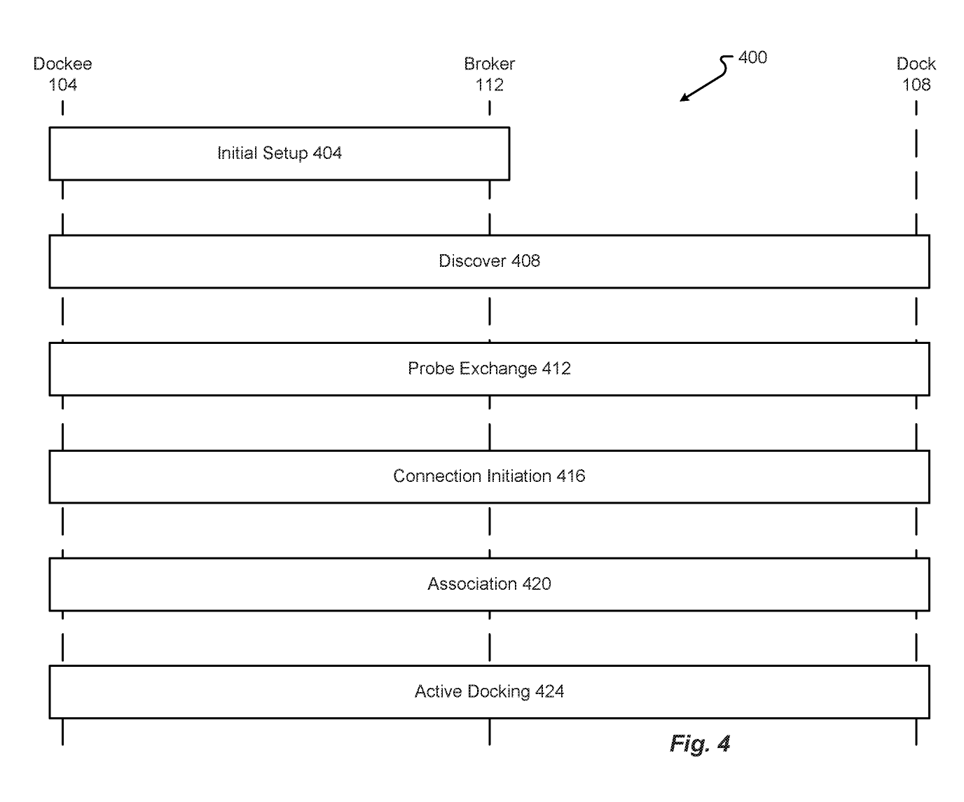

The connection logic 212a may be software/hardware that can conduct communications or establish wireless connectivity between the Dockee 104 and the Dock 108. Connection logic 212a can include processing capability to establish a desired connection, as may be described in conjunction with FIGS. 4-9. The connection logic 212a may receive information or requests from the Dock 108 that may include a token, which is sent to the token authentication generation component 208 to determine the authenticity of the token and, in turn, whether the wireless docking is desired.

The data store 216 can be any type of data repository, such as a relational database, flat file database, file system, etc. The data store 216 may store or retrieve data from a memory or storage device, as may be described in conjunction with FIG. 10. The data store 216 may include information associated with a shared secret 220a and token data 224a. Shared secret data 220a may include an encryption key or other type of encryption information that can be used to create a token and may be used to authenticate tokens that are be received from other devices. Token data 224a can be a type of shared data known between two devices such as the Dockee 104 and the Broker 112 that is used to generate the token. The token data 224a, in some configurations, is one-time data used to create a one-time token. One-time data is data that changes due to the occurrence of an event(s) or changes over time. By using the constantly changing one-time data, certain types of nefarious attacks on either the Dock 104 or the Broker 112 are prevented. For example, the one-time data in the token data 224a can include a number of times the Dockee 104 has been docked. This incrementing number then may be known between the Dockee 104 and the Broker 112 and stored as token data 224a.

The purpose of the “one-time” element 224a is to prevent a Replay attack, where an aggressor records a legitimate token transmitted during a normal connection and then uses the token to “dock” the user without her knowledge at some later time. The “one-time” element makes sure that a legitimate token is never re-used. There is no requirement to keep the token data 224a secret (but could be kept secret in some configurations) and the token data 224a may even be sent explicitly during a connection. The data element that ensures that an attacker cannot spoof or produce legitimate tokens is the shared secret 220a that must be secret and only be known to the Dockee 104 and the Broker 112.

An embodiment of hardware and/or software that form components 222 of the Broker 112 is as shown in FIG. 2B. The hardware and/or software 222 may include a communication interface 204b, a token generation component 208b, an NFC interface 228a, a data store 232, which may also include the shared secret 220b and token data 224b. The components with similar reference numerals shown in FIG. 2B may be the same or similar to those elements as described in conjunction with FIG. 2A, and thus, may not be further described herein.

The NFC interface 228a can be any type of hardware and/or software used to conduct communication over an NFC link, such as Bluetooth′ or RFID communications. The NFC signalling is conducted only over a small physical separation, such as two feet or even two inches, between the Broker 112 and the Dock 108. These NFC communications may be conducted in accordance with various standards as described in ISO/IEC 8092/ECMA-340—Near Field Communication Interface and Protocol-1 (NFCIP-1) and/or ISO/IEC 21481/ECMA-352—Near Field Communication Interface and Protocol-2 (NFCIP-2). The NFC link 220a may be used to establish the connection 120 between the Broker 112 and the Dock 108. The NFC link 120 may be conducted without further user input except to bring the Broker 112 within physical proximity of the Dock 108, which may cause the NFC interface 228 to establish automatically the connection 120.

An embodiment of hardware and/or software 234, which may be associated with the Dock 108, may be as shown in FIG. 2C. The hardware and/or software 239 herein may include a communications interface 204c, a connection logic 212b, a NFC interface 228b, which may receive a token 236 that can be provided to the connection logic 212b. Components previously described, in conjunction with FIGS. 2A and 2B, which have the same reference numeral as previous provided are the same or similar to those components described previously. As such, those previously-described components will not be further explained herein.

The token 236 may be as generated either by the Broker 112 or the Dockee 104 and sent to the Dock 108, through the NFC link 120. The token 236 may be a data signal or data packet that contains data, as described in conjunction with FIGS. 3A and/or 3B. The connection logic 212b may have a portion of hardware and/or software dedicated to sending docking association invites. The invite logic 240 may be modified, in the configurations herein, to insert a token 236 within an invitation request that may be sent to the communication interface 204 of the Dockee 104. Thus, the modified invite hardware and/or software 240 is able to insert data, as described in conjunction with FIG. 3B, to establish a wireless connection between the Dockee 104 and the Dock 108.

An embodiment of the data stored within the data store/database 220 may be as shown in FIG. 3A. As explained earlier, the data store 220 can represent any data repository, database, file system, etc. The data store 220 may be established in one or more portions that store different types of data. There may be more or fewer portions than that shown in FIG. 3A, as represented by ellipses 306. The portions within the data store 220 can include one or more of, but are not limited to, a dock identifier (ID) field 304, a key or shared secret field 308, and/or a one-time information field 312. Each one of the rows within the data store 220 can represent information associated with a particular Dock 108 and/or Broker 112. Thus, for each Dock/Broker pair, there may be different information. As such, there may be more entries or rows within the data store 220, as represented by ellipses 310.

A dock ID 304 can represent any type of unique identifier that identifies the Dock 108. This dock ID 304 can include globally unique identifiers (GUIDs) or some other type of identifier for the Dock 108.

The key or shared secret field 308 can be any information about the shared secret 220 that may be shared between the Dockee 104 and the Broker 112. Thus, the key or shared secret field 308 may be an authentication key or some other information used for some type of encryption, hush function, etc.

The one-time information 312 can be any information to create a one-time token. One-time information 312 can be a count or some other information that increments or information that may be associated with the Broker 112 or the Dockee 104 that only exists at one particular instance in time. The one-time information 312 can be used to generate the token, as explained hereinbefore.

An embodiment of token information 236 and/or information that may be sent within the invitation request described hereinafter may be as shown in FIG. 3B. The token 236 can have one or more fields or portions within communicated data, sent between the Dock 108 and the Dockee 104, which can include one or more of, but is not limited to, an element ID 316, a length 320, an organizational unique identifier (OUI ID) 324, a type field 328, a subtype field 332, and/or a data field 336. There may be more or fewer fields than those shown within FIG. 3B, as represented by ellipses 318.

The element ID 316 can identify the information type being sent. The element ID 316 can identify the information through any identifier or data unique to the information type.

The link field 320 can give a length of the data packet or the token data in bits or bytes. The length 320 may be used to ensure that no information is being added to or subtracted from the original token 236, which could signal a nefarious action in the docking.

The OUI ID 324 can identify the vendor of the Dockee 104, the Broker 112, and/or the Dock 108. This OUI ID 324 may also be used to identify the type of authentication or data that's being received and required.

The type 220 and subtype field 332 can be indications of the type of data in the data field 336. The type 320 and subtype field 332 can also be an indication of the type of token or other information within the token 236.

The data field 336 can store the token information or the encryption pseudo-random value 340. The pseudo-random value 340 may be generated by an encryption or other method, using the shared secret 308 and, in at least some configurations, the one-time information 312, shared between the Dockee 104 and the Broker 112. Thus, the data 336 can include the pseudo-random value 340 and any other data 344 that might be used or needed to authenticate the token.

A signalling diagram showing the communications 400 between a Dockee 104, a Broker 112, and a Dock 108 for establishing a docking session may be as shown in FIG. 4. The signalling process 400 may include one or more phases. Each of these phases may have a certain set of signalling exchanges between one or more of the participants 104, 108, 112. The phases may include one or more of, but are not limited to, the initial setup phase 404, the discovery phase 408, the probe exchange phase 412, the connection initiation phase 416, the association phase 420, and the active docking phase 424. The embodiments herein establish the new initial setup phase 404 and change the connection initiation phase 416. In contrast, the discovery phase 408, the probe exchange phase 412, the association phase 420, and the active docking phase 424 may be as known in the art and may be as described within one or more standards describing WiFi connectivity mentioned previously. As such, those unchanged phases 408, 412, 420, and 424 will not be fully described hereinafter.

The signalling method 400 assumes the Broker 112 is used. Generally, the user's smart-phone may be used as the Broker device 112, but other devices, for example, smart wearables may also be used. The Broker device 112 may be capable of:

NFC communications;

Storing information (10s of octets); and

Performing custom crypto functions, e.g. performing a keyed hash function and/or some encryption function.

The signalling method 400 can comprise the following:

1. Initial Setup 404—phase 404 is a pre-requisite step that can enable the docking scheme. During Initial Setup 404, the user's Broker device 112 and the Dockee 104 (which may be another of the user's devices) are “paired” by establishing a Shared Secret 308, e.g. an encryption key. Optionally, the shared secret 308 may be refreshed from time to time using any type of secured communications available between the Dockee 104 and the Broker 112.

2. Discovery 408—phase 408 is the same as in existing solutions. The Dockee 104 and the Dock 108 perform search and listen activities to discover available peers. Once an available peer is found, a Probe Exchange 412 is performed to learn of the peer's capabilities and functions. At this point, for each Dock device 108 discovered, the Dockee 104 checks the internal data store 216 for stored connection parameters (e.g., cached robust security network association (RSNA), etc.) and decides how the connection to the Dock 108 is to be made—either automatically, or following the user's explicit request through a user interface on the Dockee 104.

3. Connection Initiation 416—phase 416 is modified for the embodiments presented herein. During Connection Initiation 416, a user's explicit authorization for the connection is established. This authorization is securely achieved by the means of “tapping,” with the Broker device 112, on the Dock 108.

During this “tap”:

a. An NFC link 120 is established between the Broker 112 and the Dock 108;

b. The Broker 112 uses the Shared Secret 308 and a one-time string 312 known both to the Broker 112 and the Dockee 104 to generate a secure connection token 336. The purpose of the one-time string 312, in the generation of the token 336, is to protect against replay attacks. This one-time string 312 may, for example, be derived from a counter that is incremented upon every completed connection attempt or from a common time source. Moreover, this one time string 312 may be sent over the air along with the token 224 and may be embedded within the element 344 in the connection token. The secure token is then derived, for example, by applying a secure hash function on the concatenation of the shared secret 308 and the common known one-time string 312.

c. The Broker 112 sends the connection token 336 over NFC channel 120 to the Dock 108.

d. Upon receiving the token over NFC 120, the Dock 108 initiates a connection 124 to the Dockee 104 by means of sending an Invitation Request message, as defined in a IEEE 802.11 standard or similar message, including the information element 236 with the received token 336.

e. When receiving the token information 236 carried within the Invitation Request or any similar message, the Dockee 104 checks for the presence of the connection token 336, and authenticates the token 336 using the shared secret 308 and the one-time string 312.

f. If the token 336 exists and is successfully authenticated, the Dockee 104 replies with an Invitation Response and the peers (i.e., the Dock 108 and Dockee 104) continue to establish the connection 124.

4. Association 420—phase 420 is the same as in the existing connection methods. Peer-to-Peer (P2P) roles are assigned, the P2P client (the Dockee 104) associates with the P2P Group Owner (the Dock 108), and a secure link 124 is established.

5. Active Docking 424—once the Association step 420 is successfully completed, the docking link 124 is activated.

As mentioned above, the secure connection token 336 is delivered within the Invitation Request message, as defined in a IEEE 802.11 standard or similar message, including the information element 236 sent by the Dock 108 to the Dockee 104, after receiving the token 336 over NFC channel 120 from the Broker 112. The token 336 may be embedded into a Vendor-Specific Information Element (IE) added to the Invitation Request message 236. The structure of the suggested IE may be as presented in FIG. 3B.

In addition to the “One-Tap” scheme described above, a modified scheme, which may be used to allow for a Broker device 112 with more rudimentary hardware/software (e.g., an RFID tag or NFC smart-card) is also provided here. For such devices 112, the Broker 112 may not be capable of generating a token 336 out of a Shared Secret 308. Thus, in the modified embodiment, the Initial Setup phase 404 is eliminated. Instead, during the Connection Initiation phase 416, the user is required to first “tap” the Broker device 112 on the Dockee 104, to transfer the token 336 from the Dockee 104 to the Broker 112, and then the process 400 proceeds as described above. During the additional Broker-on-Dockee “tap,” the connection token 336 is generated by the Dockee 104, transferred to the Broker 112, and then stored on the Broker 112. The token 336 is then delivered to the Dock 108 by the second “tap” of the Broker 112, as described hereinbefore.

This modified method is less user-friendly since it requires the user to make two “taps” instead of one. However, it allows for a wider range of Broker devices 112 as it frees the Broker 112 from the need to generate the secure connection tokens 336.

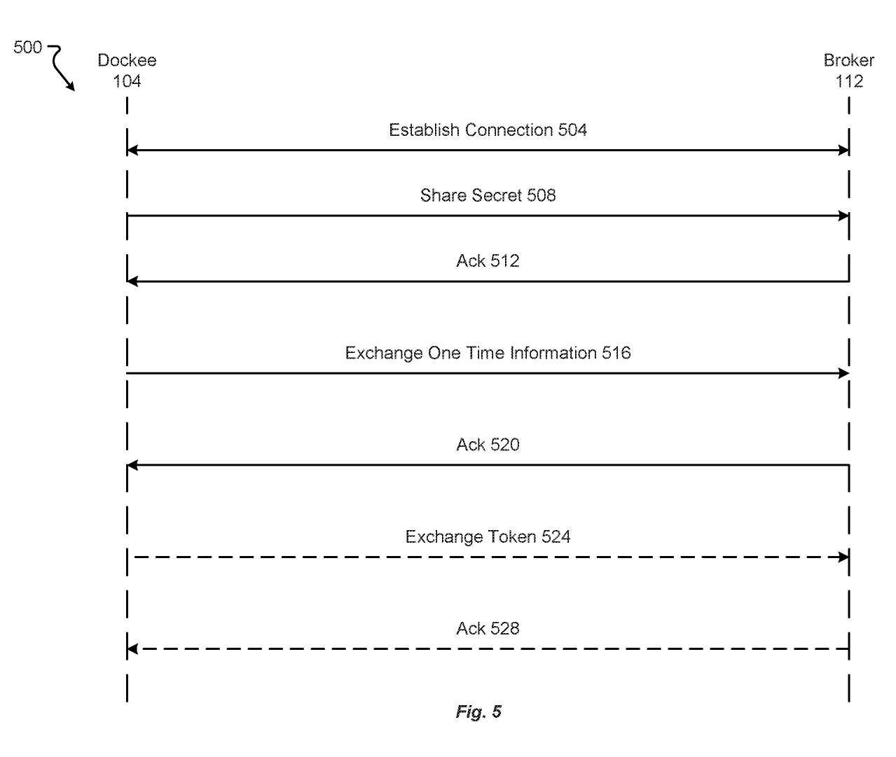

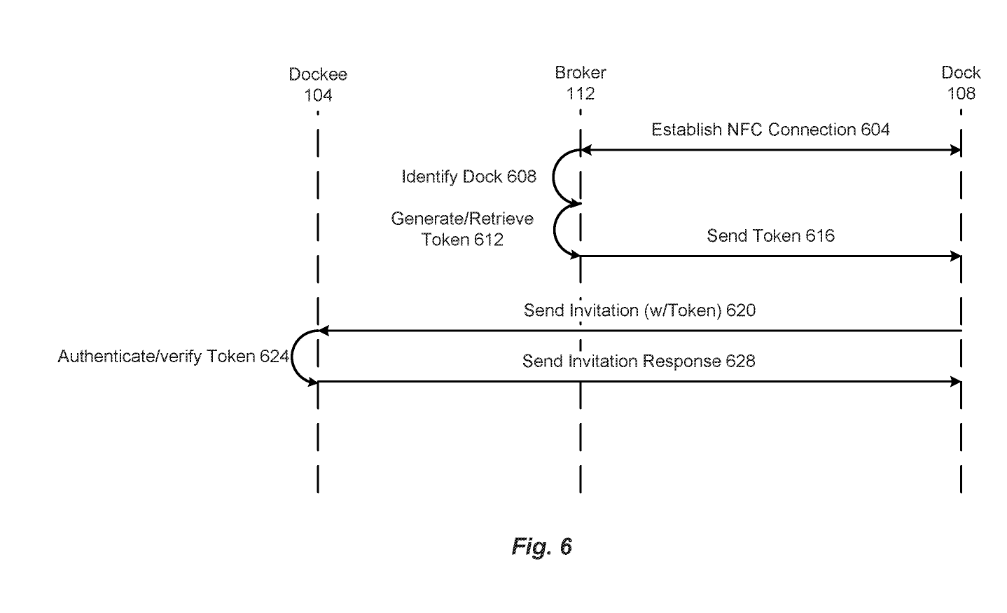

To further explain the above method, the initial setup phase 404 may be as shown in FIG. 5, while the connection initiation phase may be as shown in FIG. 6.

The signalling method 500 for conducting an initial setup phase 404 may be as shown in FIG. 5. The signalling process 500 may include one or more exchanges between the Dockee 104 and the Broker 112. A step within method 500 may represent a signal sent between devices.

In a first step 504, the Dockee 104 and Broker 112 establish a connection 116. The connection 116 may be established by connecting a physical wire or other connector between the two devices 104, 112. In other configurations, the Dockee 104 and Broker 112 may establish a secure wireless connection.

After establishment of the connection, in step 504, the Dockee 104 can share the secret information 308 with the Broker 112. The shared secret 308 may entail determining an encryption method and sending a key to the Broker 112 that is required to encrypt information. The Broker 112 may send an acknowledgment message, in step 512, to the Dockee 104 to indicate that the Broker 112 received the shared secret 308, in step 508.

The Dockee 104 may also send one-time information 312, in step 516, to the Broker 112. The one-time information 312 may be a count or some other information shared between the Dockee 104 and Broker 112 and may be updated periodically. One-time information 312 can be stored and updated by both parties after initially sending one-time information 312 to the Broker 112. In this way, any token 336 created by the Broker 112 can be properly authenticated by the Dockee 104. The Broker 112 may then again send an acknowledgment signal, in step 520, to the Dockee to acknowledge receipt of the one-time information 312.

In an optional configuration (as represented by the dashed lines), the Dockee 104 may send the complete token 336 to the Broker 112, in step 524. In these situations, the Dockee 104 generates a token 336 or information that may be permanently used by the Broker 112. This exchange may occur when the Broker 112 does not have processing ability to generate a token 336. For example, an RFID card without a processor may not be able to generate the token 336. As such, the Dockee 104 can send the token 336, in step 524, to the Broker 112, to use in the methods described hereinafter. Again, the Broker 112 may send an acknowledgment message, in signal 528, in response to the message sent in step 524.

An embodiment of the connection initiation phase 416 may be as shown in FIG. 6. The signalling process 600 may include one or more exchanges between the Dockee 104, Dock 108, and the Broker 112. A step within method 600 may represent a signal sent between devices.

Before the signalling in FIG. 6 occurs, the Dockee 104 and Dock 108, have already conducted the discovery phase 408 and the probe exchange phase 412. After the discovery phase 408 and the probe exchange phase 412, the connection initiation phase 416 begins. In the connection initiation phase 416, the Broker 108 and the Dock 112 may establish an NFC connection 120, in step 604. The NFC connection 120 may be a wireless connection that is established when the Broker 112 is brought into physical proximity with the Dock 112. In embodiments, this connection 120 may be established when the Broker 112 “taps” onto the Dock 108.

Upon establishing NFC connection 120, the Broker 112 may identify the other device 108 as a dock, in step 608. Once the Dock 108 is identified, the Broker 112 can determine that a token 336 needs to be generated, in step 612. The Broker 108 may access information in the data store 232 to generate the token 336 using an encryption method, hash function, etc. The token 336 may then be sent by the Broker 112, in step 616, to the Dock 108. The Dock 108 can receive the token 336 from the Broker 112 through the NFC connection 120. In an optional and alternative configuration, the Broker 112 may retrieve a token 336, previously created and provided by the Dockee 104 and stored on the Broker 112, in step 612. This alternative configuration may allow for the use of a Broker 112 that does not have the processing capability, e.g., an RFID card or the like, to conduct the method herein. The prepared token 336 may be provided during the docking process by a first tap of the Broker 112 on the Dockee 104.

The Dock 108 may then incorporate the token 336 into an association invitation message 236 and send such invitation 236, in step 620, to the Dockee 104. The Dockee 104 can then parse the invitation message 236 to extract the token data 336 from the invitation 236. The token 336 is then discovered, and the Dockee 104 tries to authenticate the token 336, in step 624. For authentication, the Dockee 104 can attempt to decrypt the token 336 using the shared secret 308 as a key and then verify that the decryption was successful. In situations where a secure hash function is used to generate the token 336, the Dockee 104 may verify or authenticate the received token 336 by constructing another instance of the token 336 by applying the hash function to the shared secret 308 and the one-time element 312 and then comparing the result to the received token 336. If the decryption or comparison is successful using the shared secret 308 and the token 336 is authenticated or verified, in step 624, the Dockee 104 can send an invitation response, in step 628, to the dock 108. At this point, the Dockee 104 and the Dock 108 can move to the association phase 420.

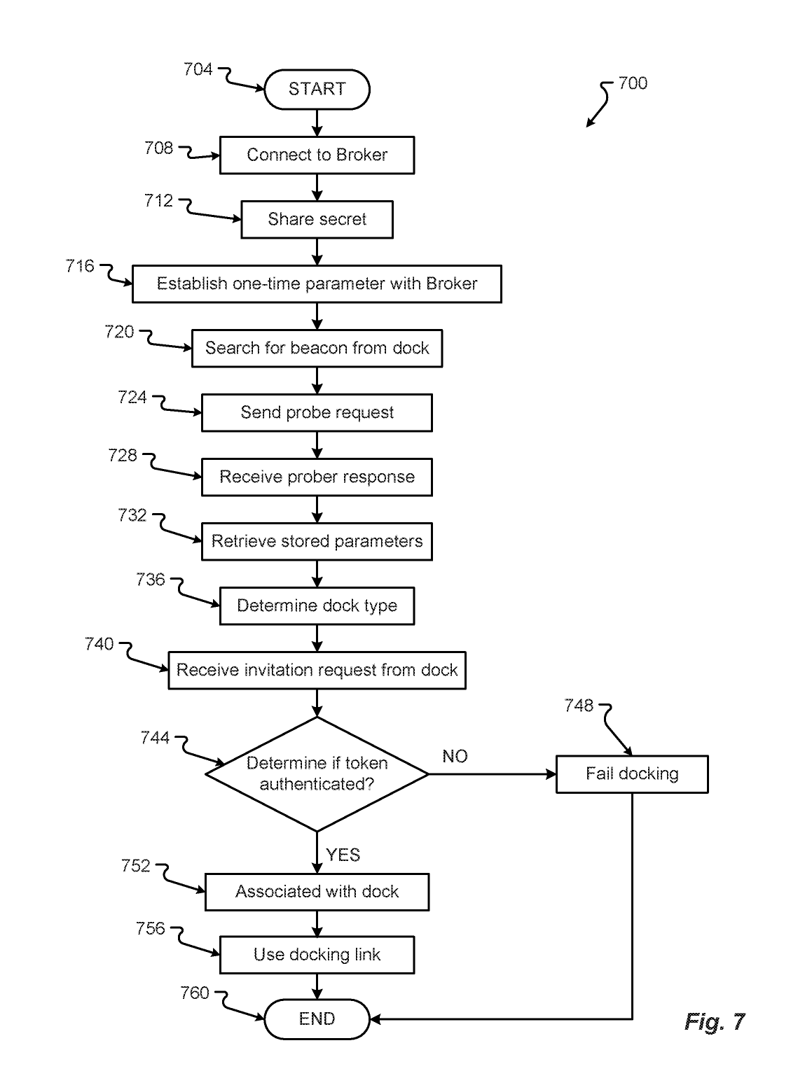

An embodiment of a method 700 for establishing a connection with the Dock 108 may be as shown in FIG. 7. The method 700 may be from the perspective of the Dockee 104. A general order for the steps of the method 700 is shown in FIG. 7. Generally, the method 700 starts with a start operation 704 and ends with an end operation 760. The method 700 can include more or fewer steps or can arrange the order of the steps differently than those shown in FIG. 7. The method 700 can be executed as a set of computer-executable instructions executed by a computer system or processor and encoded or stored on a computer readable medium. Hereinafter, the method 700 shall be explained with reference to the systems, components, circuits, modules, software, data structures, signalling processes, etc. described in conjunction with FIGS. 1-6.

The Dockee 104 connects to the Broker, in step 708. A connection 116 is established, as described in step 504, wherein a secure connection 116 between the Broker 112 and the Dockee 104 is made. This connection 116 can be wired or wireless, as described previously herein. The connection allows for the exchange of the shared secret 308 in a secure manner such that the Broker 112 and the Dockee 104 are able to establish how the token 336 should be created.

The Dockee 104 and the Broker 112 may establish the shared secret 308, in step 712. Thus, the Dockee 104 or Broker 112 can generate and provide the shared secret 308 or may establish the shared secret 308 using a known cryptographic method, for example, a Diffie-Hellman exchange or some similar exchange. An encryption key or some other type of shared secret 308 may be provided from the Dockee 104 to the Broker 112 over the secure connection 116. The shared secret 308 may be stored by both the Dockee 104 and the Broker 112 for creating or authenticating tokens 336 in the future.

Further, the Dockee 104 establishes at least one one-time parameter 312 with the Broker 112, in step 716. The one-time parameter 312 can be a count or other type of information, which may be known only to the Broker 112 and the Dockee 104, and may change over time. As such, the instance of the one-time parameter 312, at token generation time, may be different than any other time when another token 336 was generated. For example, the one-time parameter 312 can be a counter of the number of times the Dockee 104 has used a Broker 112 to establish a docking connection. Other parameters are possible, as will be evident to one skilled in the art.

Thereinafter, the Dockee 104 may search for a beacon from a Dock 108, in step 720. A Dock 108 may broadcast a beacon such that a Dockee 104 may locate or find the Dock 108 for docking. The beacon may be as described in the WiFi standards described hereinbefore. It should be noted that Dockee 104 can send beacons that are received by the Dock 108.

Upon receiving the beacon, in step 720, the Dockee 104 may send a probe request to the Dock 108, in step 724. The probe request, as understood in Wi-Fi standards, is a signal requesting information about the dock's capabilities and providing the dockee's capabilities to the Dock 108. The probe request may then be responded to, by the Dock 108, as a probe response, in step 728. The Dockee 104 can receive the probe response, which includes the information requested, and understand the capabilities of the Dock 108. It should be noted that Dock 108 can send probe requests, which are responded to by a probe response sent by the Dockee 104

After receiving the probe response 728, the Dockee 104 may retrieve stored parameters, in step 732. If a previous docking session was conducted with the Dock 108 or if there is a standard type of docking done by the Dockee 104, stored parameters in the memory or storage 216 of the Dockee 104 may be retrieved. These stored parameters can determine how the Dockee 104 may conduct the docking session with the Dock 108. For example, the store parameters can determine how communications may be conducted, etc., with the Dock 108.

From the stored parameters, the Dockee 104 can determine the type of docking, in step 736. The docking type might include a selection of a type of wireless interface, a data format, etc. Thus, the docking type can indicate frequency, bandwidth, etc. of the wireless docking connection.

Sometime thereinafter, the Dockee 104 may receive an invitation request from the Dock 108, in step 740. The invitation request can be an invitation to establish an association for conducting the docking session over a wireless link. Included within the invitation request may be a token 336, as described in conjunction with FIG. 3B. The token 336 may be extracted from the invitation request and verified by the Dockee 104.

In step 744, the Dockee 104 attempts to authenticate the token 336. By extracting and decrypting the pseudo-random value 340 using the shared secret 308 and a decryption method, the Dockee 104 can determine if the token 336 is accurate or verified as being provided from the Broker 112 to the Dock 108. Thus, the decryption with the shared secret 308 and any one-time parameter 312 can provide a value that will be understood by the Dockee 104 as being authentic. If the token 336 is authentic, the method 700 proceeds YES to the step 752. However, if the token 336 is determined not to be authentic, the method 700 proceeds NO to step 748, where the docking fails.

Upon determining that the token 336 is authentic, the Dockee 104 and the Dock 108 associate with each other, in step 752. The Dockee 104 conducts the association steps as described in conjunction with step 420 in FIG. 4. The association creates a peer-to-peer connection that allows the Dock 108 and Dockee 104 to communicate while the Dockee 104 is docked. Upon association, the Dockee 104 uses the docking link, in step 756. The docking link allows the Dockee 104 to gain access to the peripherals 128 and other connections made through the Dock 108.

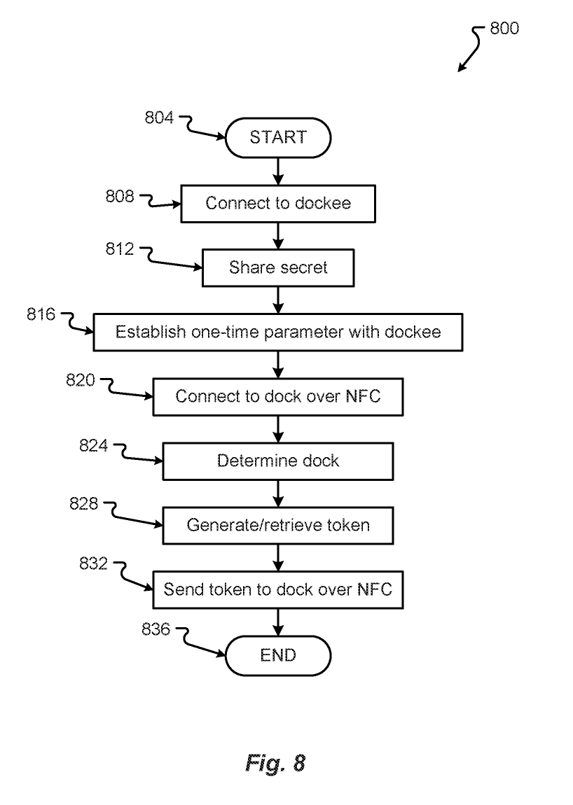

An embodiment of a method 800 for establishing a connection with the Dock 108 may be as shown in FIG. 8. The method 800 may be from the perspective of the Broker 112. A general order for the steps of the method 800 is shown in FIG. 8. Generally, the method 800 starts with a start operation 804 and ends with an end operation 836. The method 800 can include more or fewer steps or can arrange the order of the steps differently than those shown in FIG. 8. The method 800 can be executed as a set of computer-executable instructions executed by a computer system or processor and encoded or stored on a computer readable medium. Hereinafter, the method 800 shall be explained with reference to the systems, components, circuits, modules, software, data structures, signalling processes, etc. described in conjunction with FIGS. 1-7.

The Broker 112 connects with the Dockee 104, in step 808, as explained previously, in step 704 of FIG. 7 and signalling step 504 in FIG. 5. The Dockee 104 and the Broker 112 establish a secure connection 116. As also described in connection with step 712 and signalling step 508, the Broker 112 and the Dockee 104 share a secret 308, in step 812. The Broker 112 may store the shared secret 308 in secure storage within the memory 232 or storage of the device 112. The shared secret 308 may then be retrieved later on to create tokens 336. In other configurations, the Dockee 104 may share the token 336 rather than a shared secret 308 with the Broker 112. The token 336 may be stored in memory temporarily or permanently. This configuration may occur if the Broker 112 is an RFID card or similar device that does not have processing capability, as explained previously. As such, the token 336 may be stored for later use.

In step 816, the Broker 112 and the Dockee 104 can establish a one-time parameter 312. Establishment of the one-time parameter 312 may be as explained in connection with step 716 of FIG. 7. The one-time parameter 312 may be stored and updated periodically with the Broker 112. The storage of the one-time parameter 312 may be in secure storage 232 with or in association with the shared secret 308 stored in step 812. A one-time parameter 312 may be updated periodically with the Broker 112 and the Dockee 104 or changed periodically to ensure the security of any token 336 created from the one-time parameter 312 and the shared secret 308.

Sometime thereinafter, the Broker 112 connects to the Dock 108 over an NFC channel 120, in step 820. A user may tap or bring the Broker 112 within physical proximity of the Dock 108. As a result, an NFC link 120 may be established; for instance, an RFID connection or a Bluetooth™ connection may be made temporarily between the Broker 112 and the Dock 108.

The Broker 312 may then determine whether the connection to the other device 108 over NFC 120 is to a dock, in step 824. This determination is made based on information from the Dock 108, such as an ID or type of device information, sent over the NFC channel 120. This information may allow the Broker 112 to understand that the connection is to a dock.

In response to determining that a Dock 108 has been connected to over the NFC channel 120, the Broker 112 can automatically generate or retrieve a token 336, in step 828. If generating a token 336, the Broker 112 can create a token 336 from the shared secret 308 and the one-time parameter 312. The token 336 is generated by encrypting information using the shared secret 308. It should be noted that the token 336 may be generated by other methods instead of encryption, for example, by a keyed hashing using a strong hashing function, as described previously. If the Broker 112 is retrieving the token 336, the Broker 112 can retrieve the token 336 from memory 232 within the Broker 112.

The token 336, once generated or retrieved, may be sent over the NFC channel 120 to the Dock 108, in step 832. Here, the token 336 may be provided as an encrypted value that may be used by the Dock 108 to connect with the Dockee 104. The token 336 may have some type of data packet wrapper identifying the token 336 or how the token 336 was generated.

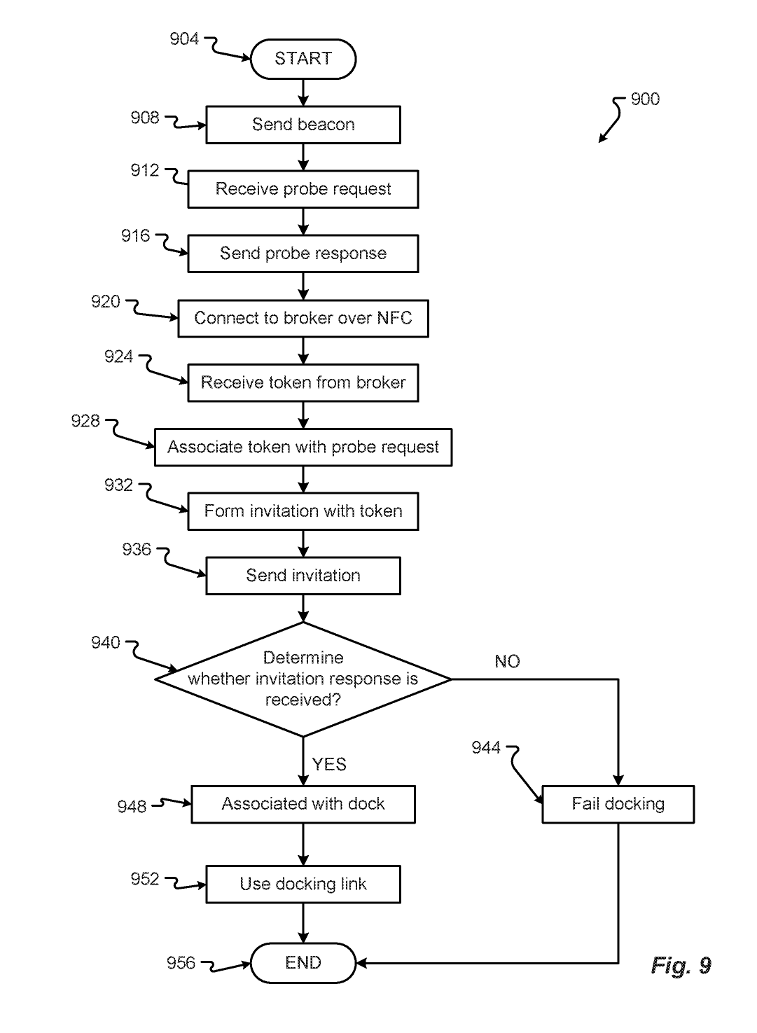

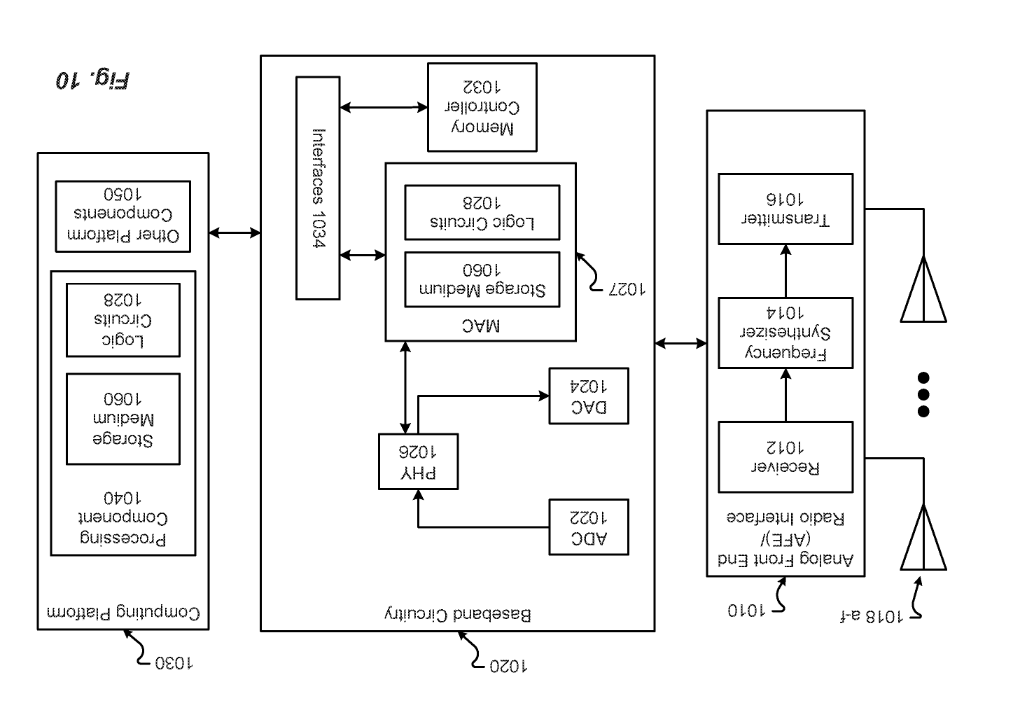

An embodiment of a method 900 for establishing a connection with the Dock 109 may be as shown in FIG. 9. The method 900 may be from the perspective of the Dock 108. A general order for the steps of the method 900 is shown in FIG. 9. Generally, the method 900 starts with a start operation 904 and ends with an end operation 956. The method 900 can include more or fewer steps or can arrange the order of the steps differently than those shown in FIG. 9. The method 900 can be executed as a set of computer-executable instructions executed by a computer system or processor and encoded or stored on a computer readable medium. Hereinafter, the method 900 shall be explained with reference to the systems, components, circuits, modules, software, data structures, signalling processes, etc. described in conjunction with FIGS. 1-8.

Per the previously-described WiFi standards, the Dock 108 (or Dockee 104) may send periodic beacons, in step 908. These beacons allow other devices to discover the presence of the Dock 108 (or Dockee 104) in the computing environment. These beacons may be as described within one or more wireless standards.

Sometime thereinafter and in response to a sent beacon, the Dock 108 (or Dockee 104) can receive a probe request from a Dockee 104 (or Dock 108), in step 912. The probe request, as explained previously in conjunction with step 724 of FIG. 7, may request information about the Dock 108 (or Dockee 104) and may provide information about the Dockee 104 (or Dock 108). The probe request causes the Dock 108 (or Dockee 104) to send a probe response, in step 916. As explained in step 728 of FIG. 7, the probe response provides information about the Dock 108 (or Dockee 104) and any other parameters needed by the Dockee 104 (or Dock 108) to dock with the Dock 108 (or Dockee 104).

Thereinafter and in temporal proximity to the exchange of the probe request and probe response, the Dock 108 can connect to the Broker 112 over an NFC connection 120, in step 920. The temporal proximity of the probe response and request will allow the Dock 108 to understand that any material or token 336 provided over the now-connected Broker 112 is in regards to the docking session beginning to be established by the probe request and probe response. The connection with the Broker 112 is conducted when the Broker 112 comes within physical proximity of the Dock 108. Upon the NFC connection 120 being established, the Dock 108 can receive the token 336 from the Broker 112, in step 924. The token information may then be associated with the probe request and response, in step 928.

The token 336 is then incorporated into an information element 236 formed by the Dock 108, in step 932. Thus, the information element 236 can include the information as described in conjunction with FIG. 3B, including the token 336. This information 236 may then be sent to the Dockee 104, in step 936. Here, the Invitation Request message, as defined in a IEEE 802.11 standard or similar message, including the information element 236 may be sent as an association invitation, as described in Wi-Fi standards and in response to the probe request 912 previously received.

For some time thereinafter, the Dock 108 waits to receive an invitation response. The Dock 108 may then wait for that period of time and determine if an invitation response in response to the invitation request is received, in step 940. Thus, for a minute, five minutes, or some predetermined amount of time, the Dock 108 can wait for an invitation response. If an invitation response is received, the method 900 proceeds YES to step 948. If no invitation response is received, the method 900 proceeds NO to failing the docking in step 944.

In step 948, the Dock 108 and Dockee 104 may conduct an association to form a peer-to-peer pairing to allow for the docking session. This P2P paring may be as described in conjunction with step 752 in FIG. 7. Thereinafter, the Dockee 104 may use the docking link to conduct operations with peripherals 128 or with other connections or devices connected with the Dock 108, in step 952.

Device Architecture:

FIG. 10 illustrates an embodiment of a device 1000 that may implement one or more devices 104, 108, 112 of FIG. 1. In various embodiments, device 1000 may comprise a logic circuit 1028. The logic circuit 1028 may include physical circuits to perform operations described for one or more devices 102 of FIG. 1, for example. The logic circuit 1028 may implement the hardware/software described in conjunction with FIGS. 2A-2C. As shown in FIG. 10, device 1000 may include one or more of, but is not limited to, a radio interface 1010, baseband circuitry 1020, and/or computing platform 1030.

The device 1000 may implement some or all of the structure and/or operations for one or more devices 102 of FIG. 1, storage medium 1060, and logic circuit 1028 in a single computing entity, such as entirely within a single device 104, 108, 112. Alternatively, the device 1000 may distribute portions of the structure and/or operations for one or more devices 104, 108, 112 of FIG. 1, storage medium 1060, and logic circuit 1028 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems.

An analog front end (AFE)/radio interface 1010 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the configurations are not limited to any specific over-the-air interface or modulation scheme. AFE/Radio interface 1010 may include, for example, a receiver 1012, a frequency synthesizer 1014, and/or a transmitter 1016. AFE/Radio interface 1010 may include bias controls, a crystal oscillator, and/or one or more antennas 1018-f In additional or alternative configurations, the AFE/Radio interface 1010 may use external voltage-controlled oscillators (VCOs), surface acoustic wave filters, intermediate frequency (IF) filters and/or RF filters, as desired.

Baseband circuitry 1020 may communicate with AFE/Radio interface 1010 to process, receive, and/or transmit signals and may include, for example, an analog-to-digital converter 1022 for down converting received signals, a digital-to-analog converter 1024 for up converting signals for transmission. Further, baseband circuitry 1020 may include a baseband or physical layer (PHY) processing circuit 1026 for the PHY link layer processing of respective receive/transmit signals. Baseband circuitry 1020 may include, for example, a medium access control (MAC) processing circuit 1027 for MAC/data link layer processing. Baseband circuitry 1020 may include a memory controller 1032 for communicating with MAC processing circuit 1027 and/or a computing platform 1030, for example, via one or more interfaces 1034.

In some configurations, PHY processing circuit 1026 may include a frame construction and/or detection module, in combination with additional circuitry such as a buffer memory, to construct and/or deconstruct communication frames. Alternatively, or in addition, MAC processing circuit 1027 may share processing for certain of these functions or perform these processes independent of PHY processing circuit 1026. In some configurations, MAC and PHY processing may be integrated into a single circuit.

The computing platform 1030 may provide computing functionality for the device 1000. As shown, the computing platform 1030 may include a processing component 1040. In addition to, or alternatively of, the baseband circuitry 1020, the device 1000 may execute processing operations or logic for one or more of devices 104, 108, 112, storage medium 1060, and logic circuit 1028 using the processing component 1040. The processing component 1040 (and/or PHY 1026 and/or MAC 1027) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1030 may further include other platform components 1050. Other platform components 1050 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units 1060 may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1000 may be, for example, an ultra-mobile device, a mobile device, a fixed device, a machine-to-machine (M2M) device, a personal digital assistant (PDA), a mobile computing device, a dock, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 1000 described herein, may be included or omitted in various embodiments of device 1000, as suitably desired.

Embodiments of device 1000 may be implemented using single input single output (SISO) architectures. However, certain implementations may include multiple antennas (e.g., antennas 1018-f) for transmission and/or reception using adaptive antenna techniques for beamforming or spatial division multiple access (SDMA) and/or using MIMO communication techniques.

The components and features of device 1000 may be implemented using any combination of discrete circuitry, application specific integrated circuits (ASICs), logic gates and/or single chip architectures. Further, the features of device 1000 may be implemented using microcontrollers, programmable logic arrays and/or microprocessors or any combination of the foregoing where suitably appropriate. It is noted that hardware, firmware, and/or software elements may be collectively or individually referred to herein as “logic,” “circuit,” or “processor.”

The device in FIG. 10 can also contain a security module (not shown). This security module can contain information regarding, but not limited to, security parameters required to connect the device to another device or other available networks or network devices, and can include WEP or WPA security access keys, network keys, etc., as discussed.

Another module that the device in FIG. 10 can include is a network access unit (not shown). The network access unit can be used for connecting with another network device. In one example, connectivity can include synchronization between devices. In another example, the network access unit can work as a medium which provides support for communication with other stations. In yet another example, the network access unit can work in conjunction with at least the MAC circuitry 1027. The network access unit can also work and interact with one or more of the modules/components described herein.

It should be appreciated that the exemplary device 1000 shown in the block diagram of FIG. 10 may represent one functionally descriptive example of many potential implementations. Accordingly, division, omission, or inclusion of block functions depicted in the accompanying figures does not infer that the hardware components, circuits, software and/or elements for implementing these functions would be necessarily be divided, omitted, or included in embodiments.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Furthermore, it should be appreciated that some of the various links, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, Wi-Fi, LTE, 4G, Bluetooth®, WirelessHD, WiGig, WiGi, 3GPP, Wireless LAN, WiMAX, and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A10 processor with 64-bit architecture, Apple® M10 motion coprocessors, Samsung® Exynos® series, the Intel® Core™ family of processors, the Intel® Xeon® family of processors, the Intel® Atom™ family of processors, the Intel Itanium® family of processors, Intel® Core® i5-46100K and i10-410100K 22 nm Haswell, Intel® Core® i5-35100K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM41004/BCM41003 wireless networking processors, the AR10100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA.®. or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhanced communications. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

Exemplary aspects are directed toward:

A dock in a wireless docking system, the dock comprising: a first communications interface in communication with a dockee device; a second communications interface in communication with a broker device; a processor in communication with the first communications interface and the second communications interface, the processor to: receive a token from the broker device over the second connection, wherein the token is generated from a shared secret established between the dockee device and the broker device; generate an invitation request for the dockee device, wherein the invitation request includes the token, wherein the dockee device authenticates the token based on the shared secret; send the invitation request to the dockee device; receive the invitation response from the dockee device to establish the docking session; and in response to receiving the invitation response, establish the docking session.

Any one or more of the above aspects, wherein the token is formed from a shared secret, and where the shared secret is an encryption key.

Any one or more of the above aspects, the processor further to: receive a user action; and based on the user action, establish communications with the broker device.

Any one or more of the above aspects, wherein the user action is a physical action that brings the broker device within physical proximity of the dock and wherein the physical action indicates a user's desire to dock the dockee device with the dock.

Any one or more of the above aspects, wherein the second communications interface is a near field communications (NFC) connection interface.

Any one or more of the above aspects, wherein the processor is further to: send a beacon to the dockee; in response to the beacon, receive a probe request from the dockee before sending the invitation request; and send a probe response to the dockee.

Any one or more of the above aspects, wherein the token is further generated from a one-time parameter established between the dockee device and the broker device.

Any one or more of the above aspects, wherein the token is a pseudo-random value produced with an encryption method using the shared secret and the one-time parameter.

Any one or more of the above aspects, wherein the one-time parameter is a count or a value from a common time source.

A method comprising: receiving a token from the broker device over the second connection, wherein the token is generated from a shared secret established between the dockee device and the broker device; generating an invitation request for the dockee device, wherein the invitation request includes the token, wherein the dockee device authenticates the token based on the shared secret; sending the invitation request to the dockee device; receiving the invitation response from the dockee device to establish the docking session; and in response to receiving the invitation response, establishing the docking session.

Any one or more of the above aspects, wherein the token is formed from a shared secret, and where the shared secret is an encryption key.

Any one or more of the above aspects, further comprising: receiving a user action; and based on the user action, establishing communications with the broker device.

Any one or more of the above aspects, wherein the user action is a physical action that brings the broker device within physical proximity of the dock and wherein the physical action indicates a user's desire to dock the dockee device with the dock.

Any one or more of the above aspects, wherein the second communications interface is a near field communications (NFC) connection interface.

Any one or more of the above aspects, further comprising: sending a beacon to the dockee; in response to the beacon, receiving a probe request from the dockee before sending the invitation request; and sending a probe response to the dockee.

Any one or more of the above aspects, wherein the token is further generated from a one-time parameter established between the dockee device and the broker device.

Any one or more of the above aspects, wherein the token is a pseudo-random value produced with an encryption method using the shared secret and the one-time parameter.

Any one or more of the above aspects, wherein the one-time parameter is a count or a value from a common time source.

A dock in a wireless docking system, the dock comprising: means for receiving a token from the broker device over the second connection, wherein the token is generated from a shared secret established between the dockee device and the broker device; means for generating an invitation request for the dockee device, wherein the invitation request includes the token, wherein the dockee device authenticates the token based on the shared secret; means for sending the invitation request to the dockee device; means for receiving the invitation response from the dockee device to establish the docking session; and in response to receiving the invitation response, means for establishing the docking session.

Any one or more of the above aspects, wherein the token is formed from a shared secret, and where the shared secret is an encryption key.

Any one or more of the above aspects, further comprising: means for receiving a user action; and based on the user action, means for establishing communications with the broker device.

Any one or more of the above aspects, wherein the user action is a physical action that brings the broker device within physical proximity of the dock and wherein the physical action indicates a user's desire to dock the dockee device with the dock.

Any one or more of the above aspects, wherein the second communications interface is a near field communications (NFC) connection interface.

Any one or more of the above aspects, further comprising: means for sending a beacon to the dockee; in response to the beacon, means for receiving a probe request from the dockee before sending the invitation request; and means for sending a probe response to the dockee.

Any one or more of the above aspects, wherein the token is further generated from a one-time parameter established between the dockee device and the broker device.

Any one or more of the above aspects, wherein the token is a pseudo-random value produced with an encryption method using the shared secret and the one-time parameter.

Any one or more of the above aspects, wherein the one-time parameter is a count or a value from a common time source.

A non-transitory information storage media having stored thereon one or more instructions, that when executed by one or more processors, cause a wireless communications device to perform a method comprising: receiving a token from the broker device over the second connection, wherein the token is generated from a shared secret established between the dockee device and the broker device; generating an invitation request for the dockee device, wherein the invitation request includes the token, wherein the dockee device authenticates the token based on the shared secret; sending the invitation request to the dockee device; receiving the invitation response from the dockee device to establish the docking session; and in response to receiving the invitation response, establishing the docking session.

Any one or more of the above aspects, wherein the token is formed from a shared secret, and where the shared secret is an encryption key.

Any one or more of the above aspects, the method further comprising: receiving a user action; and based on the user action, establishing communications with the broker device.

Any one or more of the above aspects, wherein the user action is a physical action that brings the broker device within physical proximity of the dock and wherein the physical action indicates a user's desire to dock the dockee device with the dock.

Any one or more of the above aspects, wherein the second communications interface is a near field communications (NFC) connection interface.

Any one or more of the above aspects, the method further comprising: sending a beacon to the dockee; in response to the beacon, receiving a probe request from the dockee before sending the invitation request; and sending a probe response to the dockee.

Any one or more of the above aspects, wherein the token is further generated from a one-time parameter established between the dockee device and the broker device.

Any one or more of the above aspects, wherein the token is a pseudo-random value produced with an encryption method using the shared secret and the one-time parameter.

Any one or more of the above aspects, wherein the one-time parameter is a count or a value from a common time source.

A non-transitory information storage media having stored thereon one or more instructions, that when executed by one or more processors, cause a wireless communications device to perform a method comprising: sharing one of a token or a shared secret with a broker device over a first connection, wherein the token is generated from the shared secret;

receiving an invitation request from a dock, wherein the invitation request includes a token provided by the broker device to the dock; authenticating the token based on the shared secret; and in response to authenticating the token, sending an invitation response to the dock to establish a docking session.

Any one or more of the above aspects, the method further comprising: receiving a beacon from the dock; in response to the beacon, sending a probe request to the dock before receiving the invitation request; and receiving a probe response from the dock.

Any one or more of the above aspects, wherein, if the broker device is unable to generate the token, sending the token to the broker device.

Any one or more of the above aspects, the method further comprising sharing a one-time parameter with the broker device.

Any one or more of the above aspects, wherein the token, generated by the broker device, is a pseudo-random value produced with an encryption method using the shared secret and the one-time parameter.

Any one or more of the above aspects, wherein the broker sends the token to the dock based on a user action, wherein the user action is a physical action that brings the broker device within physical proximity of the dock, and wherein the physical action indicates a user's desire to dock with the dock.

A method comprising: a dockee device sharing one of a token or a shared secret with a broker device over a first connection, wherein the token is generated from the shared secret; the dockee device receiving an invitation request from a dock, wherein the invitation request includes a token provided by the broker device to the dock; the dockee device authenticating the token based on the shared secret; and in response to authenticating the token, the dockee device sending an invitation response to the dock to establish a docking session.

Any one or more of the above aspects, the method further comprising:

the dockee device receiving a beacon from the dock; in response to the beacon, the dockee device sending a probe request to the dock before receiving the invitation request; and

the dockee device receiving a probe response from the dock.

Any one or more of the above aspects, wherein, if the broker device is unable to generate the token, sending the token to the broker device.

Any one or more of the above aspects, the method further comprising sharing a one-time parameter with the broker device.

Any one or more of the above aspects, wherein the token, generated by the broker device, is a pseudo-random value produced with an encryption method using the shared secret and the one-time parameter.

Any one or more of the above aspects, wherein the broker sends the token to the dock based on a user action, wherein the user action is a physical action that brings the broker device within physical proximity of the dock, and wherein the physical action indicates a user's desire to dock with the dock.

A dockee device in a wireless docking system, the dockee device comprising:

a first communications interface in communication with a dock device; a second communications interface in communication with a broker device; a processor in communication with the first communications interface and the second communications interface, the processor to: share one of a token or a shared secret with a broker device over the second communications interface, wherein the token is generated from the shared secret; receive an invitation request from a dock over the first communications interface, wherein the invitation request includes the token provided by the broker device to the dock; authenticate the token based on the shared secret; and in response to authenticating the token, send an invitation response to the dock to establish a docking session over the first communications interface.

Any one or more of the above aspects, the processor further to: receive a beacon from the dock; in response to the beacon, send a probe request to the dock before receiving the invitation request; and receive a probe response from the dock.

Any one or more of the above aspects, wherein, if the broker device is unable to generate the token, sending the token to the broker device.

Any one or more of the above aspects, the processor further to share a one-time parameter with the broker device.

Any one or more of the above aspects, wherein the token, generated by the broker device, is a pseudo-random value produced with an encryption method using the shared secret and the one-time parameter.

Any one or more of the above aspects, wherein the broker sends the token to the dock based on a user action, wherein the user action is a physical action that brings the broker device within physical proximity of the dock, and wherein the physical action indicates a user's desire to dock with the dock.

A dockee device in a wireless docking system, the dockee device comprising: means for sharing one of a token or a shared secret with a broker device over a first connection, wherein the token is generated from the shared secret; means for receiving an invitation request from a dock, wherein the invitation request includes a token provided by the broker device to the dock; means for authenticating the token based on the shared secret; and in response to authenticating the token, means for sending an invitation response to the dock to establish a docking session.

Any one or more of the above aspects, further comprising: means for receiving a beacon from the dock; in response to the beacon, means for sending a probe request to the dock before receiving the invitation request; and means for receiving a probe response from the dock.

Any one or more of the above aspects, wherein, if the broker device is unable to generate the token, sending the token to the broker device.

Any one or more of the above aspects, further comprising means for sharing a one-time parameter with the broker device.

Any one or more of the above aspects, wherein the token, generated by the broker device, is a pseudo-random value produced with an encryption method using the shared secret and the one-time parameter.

Any one or more of the above aspects, wherein the broker sends the token to the dock based on a user action, wherein the user action is a physical action that brings the broker device within physical proximity of the dock, and wherein the physical action indicates a user's desire to dock with the dock.

A method comprising: a broker device receiving a shared secret and a one-time parameter over a first connection from a dockee device; the broker device receiving a user action; based on the user action: the broker device establishing a second connection with a dock; the broker device generating a token based on the shared secret and the one-time parameter; and the broker device sending the token to the dock over the second connection, wherein the dock sends the token to the dockee device to establish a docking connection.

Any one or more of the above aspects, wherein the shared secret is an encryption key.

Any one or more of the above aspects, wherein the user action is a physical action that brings the broker device within physical proximity of the dock and wherein the physical action indicates a user's desire to dock the dockee device with the dock.

Any one or more of the above aspects, wherein the second connection is a near field communications (NFC) connection.

Any one or more of the above aspects, wherein the token is a pseudo-random value produced with an encryption method using the shared secret and the one-time parameter.

Any one or more of the above aspects, wherein the one-time parameter is a count or a value from a common time source.

A non-transitory information storage media having stored thereon one or more instructions, that when executed by one or more processors, cause a wireless communications device to perform a method comprising: receiving a shared secret and a one-time parameter over a first connection from a dockee device; receiving a user action; based on the user action: establishing a second connection with a dock; generating a token based on the shared secret and the one-time parameter; and sending the token to the dock over the second connection, wherein the dock sends the token to the dockee device to establish a docking connection.

Any one or more of the above aspects, wherein the shared secret is an encryption key.

Any one or more of the above aspects, wherein the user action is a physical action that brings the broker device within physical proximity of the dock and wherein the physical action indicates a user's desire to dock the dockee device with the dock.

Any one or more of the above aspects, wherein the second connection is a near field communications (NFC) connection.

Any one or more of the above aspects, wherein the token is a pseudo-random value produced with an encryption method using the shared secret and the one-time parameter.

Any one or more of the above aspects, wherein the one-time parameter is a count or a value from a common time source.

A broker device in a wireless docking system, the broker device comprising: a first communications interface in communication with a dockee device; a second communications interface in communication with a dock device; a processor in communication with the first communications interface and the second communications interface, the processor to: receive a shared secret and a one-time parameter over the first communications interface from a dockee device; receive a user action; based on the user action: establish a second connection with a dock over the second communications interface;

generate a token based on the shared secret and the one-time parameter; and send the token to the dock over the second connection, wherein the dock sends the token to the dockee device to establish a docking connection.

Any one or more of the above aspects, wherein the shared secret is an encryption key.

Any one or more of the above aspects, wherein the user action is a physical action that brings the broker device within physical proximity of the dock and wherein the physical action indicates a user's desire to dock the dockee device with the dock.

Any one or more of the above aspects, wherein the second connection is a near field communications (NFC) connection.

Any one or more of the above aspects, wherein the token is a pseudo-random value produced with an encryption method using the shared secret and the one-time parameter.

Any one or more of the above aspects, wherein the one-time parameter is a count or a value from a common time source.

A broker device in a wireless docking system, the broker device comprising: means for receiving a shared secret and a one-time parameter over a first connection from a dockee device; means for receiving a user action; based on the user action: means for establishing a second connection with a dock; means for generating a token based on the shared secret and the one-time parameter; and means for sending the token to the dock over the second connection, wherein the dock sends the token to the dockee device to establish a docking connection.

Any one or more of the above aspects, wherein the shared secret is an encryption key.

Any one or more of the above aspects, wherein the user action is a physical action that brings the broker device within physical proximity of the dock and wherein the physical action indicates a user's desire to dock the dockee device with the dock.

Any one or more of the above aspects, wherein the second connection is a near field communications (NFC) connection.

Any one or more of the above aspects, wherein the token is a pseudo-random value produced with an encryption method using the shared secret and the one-time parameter.

Any one or more of the above aspects, wherein the one-time parameter is a count or a value from a common time source.

1. A dock in a wireless docking system, the dock comprising:
a first communications interface in communication with a dockee device;
a second communications interface in communication with a broker device;
a processor in communication with the first communications interface and the second communications interface, the processor to:
receive a token from the broker device over the second connection, wherein the token is generated from a shared secret established between the dockee device and the broker device;
generate an invitation request for the dockee device, wherein the invitation request includes the token, wherein the dockee device authenticates the token based on the shared secret;
send the invitation request to the dockee device;
receive the invitation response from the dockee device to establish the docking session; and
in response to receiving the invitation response, establish the docking session.

2. The dock in a wireless docking system of claim 1, wherein the token is formed from a shared secret, and where the shared secret is an encryption key.

3. The dock in a wireless docking system of claim 1, the processor further to:
receive a user action; and
based on the user action, establish communications with the broker device.

4. The dock in a wireless docking system of claim 1, wherein the user action is a physical action that brings the broker device within physical proximity of the dock and wherein the physical action indicates a user's desire to dock the dockee device with the dock.

5. The dock in a wireless docking system of claim 4, wherein the second communications interface is a near field communications (NFC) connection interface.

6. The dock in a wireless docking system of claim 1, wherein the processor is further to:
send a beacon to the dockee;
in response to the beacon, receive a probe request from the dockee before sending the invitation request; and
send a probe response to the dockee.

7. The dock in a wireless docking system of claim 1, wherein the token is further generated from a one-time parameter established between the dockee device and the broker device.

8. The dock in a wireless docking system of claim 7, wherein the token is a pseudo-random value produced with an encryption method using the shared secret and the one-time parameter.

9. The dock in a wireless docking system of claim 8, wherein the one-time parameter is a count or a value from a common time source.

10. A non-transitory information storage media having stored thereon one or more instructions, that when executed by one or more processors, cause a wireless communications device to perform a method comprising:
sharing one of a token or a shared secret with a broker device over a first connection, wherein the token is generated from the shared secret;
receiving an invitation request from a dock, wherein the invitation request includes a token provided by the broker device to the dock;
authenticating the token based on the shared secret; and
in response to authenticating the token, sending an invitation response to the dock to establish a docking session.

11. The media of claim 10, further comprising:
receiving a beacon from the dock;
in response to the beacon, sending a probe request to the dock before receiving the invitation request; and
receiving a probe response from the dock.

12. The media of claim 10, wherein, if the broker device is unable to generate the token, sending the token to the broker device.

13. The media of claim 10, further comprising sharing a one-time parameter with the broker device.

14. The media of claim 13, wherein the token, generated by the broker device, is a pseudo-random value produced with an encryption method using the shared secret and the one-time parameter.

15. The media of claim 14, wherein the broker sends the token to the dock based on a user action, wherein the user action is a physical action that brings the broker device within physical proximity of the dock, and wherein the physical action indicates a user's desire to dock with the dock.

16. A method comprising:
a broker device receiving a shared secret and a one-time parameter over a first connection from a dockee device;
the broker device receiving a user action;
based on the user action:
the broker device establishing a second connection with a dock;
the broker device generating a token based on the shared secret and the one-time parameter; and
the broker device sending the token to the dock over the second connection, wherein the dock sends the token to the dockee device to establish a docking connection.

17. The method of claim 16, wherein the shared secret is an encryption key.

18. The method of claim 16, wherein the user action is a physical action that brings the broker device within physical proximity of the dock and wherein the physical action indicates a user's desire to dock the dockee device with the dock.

19. The method of claim 16, wherein the second connection is a near field communications (NFC) connection.

20. The method of claim 16, wherein the token is a pseudo-random value produced with an encryption method using the shared secret and the one-time parameter.

21. The method of claim 16, wherein the one-time parameter is a count or a value from a common time source.
